(19) United States
(12) Patent Application Publication
(10) Pub. No.: US 2025/0077623 A1
(43) Pub. Date: Mar. 6, 2025

(54) ROOT CAUSE TAXONOMY GENERATOR

(71) Applicant: Microsoft Technology Licensing, LLC, Redmond, WA (US)

(72) Inventors: Zhongkai LIU, Redmond, WA (US); Lavaleen Kumar JHA, Bothell, WA (US)

(21) Appl. No.: 18/459,638

(22) Filed: Sep. 1, 2023

(51) Int. Cl. G06F 18/24

(52) U.S. Cl. CPC G06F 18/24765

(57) ABSTRACT

Systems, methods, apparatuses, and computer program products are disclosed for generating a root cause taxonomy from incident data. Top-level classification(s) and incident data are received as inputs. The incident data is processed to generate processed incident data, which is then analyzed to determine patterns in the processed incident data. Second-level classification are generated based on the determined patterns, and added to the root cause taxonomy. The root cause taxonomy may then be used to classify incidents in the incident data.

### BACKGROUND

Root cause analysis (RCA) is a systematic approach used in incident management to identify the underlying or fundamental cause of an incident or problem. RCA aims to go beyond addressing immediate symptoms or visible issues and instead seeks to uncover the root cause, which, when resolved, can prevent similar incidents from occurring in the future. Root cause classification involves categorizing the identified cause of the incident or problem into distinct groups or types based on shared characteristics or patterns.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, apparatuses, and computer program products are disclosed for generating a root cause taxonomy from incident data. Top-level classification(s) and incident data are received as inputs. The incident data is processed to generate processed incident data, which is then analyzed to determine patterns in the processed incident data. Second-level classifications are generated based on the determined patterns, and added to the root cause taxonomy. The root cause taxonomy may then be used to classify incidents in the incident data.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for generating a root cause taxonomy, in accordance with an embodiment.

FIG. 2 shows a block diagram of an example system for generating a root cause taxonomy, in accordance with an embodiment.

FIG. 3 depicts a flowchart of a process for generating a root cause taxonomy, in accordance with an embodiment.

FIG. 4 depicts a flowchart of process for identifying patterns in incident data, in accordance with an embodiment.

FIG. 5 depicts a flowchart of a process for generating hierarchical classifications based on patterns identified in incident data, in accordance with an embodiment.

FIG. 6 depicts a flowchart of process for generating hierarchical classifications based on patterns identified in incident data, in accordance with an embodiment.

FIG. 7 depicts a flowchart of a process for preprocessing incident data, in accordance with an embodiment.

FIG. 8 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Root cause analysis (RCA) enables the handling of incidents at their source rather than merely treating the symptoms. For example, by identifying and addressing the root cause, organizations can implement preventive measures to avoid similar incidents in the future. This proactive approach helps minimize the impact of incidents, reduces downtime, and enhances overall system reliability. Furthermore, RCA allows organizations to learn from incidents, identify weaknesses or gaps in their processes, and make necessary adjustments to enhance efficiency, performance, and customer satisfaction. RCA can also lead to cost savings by eliminating recurring incidents. Instead of repeatedly dealing with the same problem, resources can be allocated to more productive tasks, ultimately improving productivity and reducing operational expenses. By collecting and analyzing data related to incidents, RCA can provide valuable insights into patterns, trends, and common issues, enabling organizations to make informed decisions about process improvements, system upgrades, or infrastructure changes.

Embodiments disclosed herein are directed to an RCA methodology that combines data preprocessing techniques with a structured taxonomy approach. In an embodiment, RCA begins with textual preprocessing, which may involve collecting and organizing incident data, such as, but not limited to, incident reports, user feedback, and/or system logs. In embodiments, textual preprocessing includes, but is not limited to, cleansing, standardizing, stemming, lemmatizing, removing stop words, removing special characters, removing hyperlinks, and/or structuring the incident data into processed incident data that facilitates data analysis thereof. After textual preprocessing, a root cause taxonomy is created based on the processed incident data by categorizing and classifying the incidents based on common themes and/or patterns in the processed incident data. Once the root cause taxonomy is established, the incident data is mapped to root cause categories to enable the identification of recurring patterns, trends, and/or systemic issues contributing to the incidents.

In embodiments, textual preprocessing of incident data may include, but is not limited to, one or more of the following: converting the incident data into a string format; perform textual cleaning of the incident data; removing web links and/or addresses from the incident data; replacing text matching specific words, phrase, and/or patterns in the incident data; perform case normalization on the incident data; preprocessing specific fields in the incident data; replacing underscores in the incident data; tokenizing the incident data; removing stop words from the incident data; and/or lemmatizing the incident data. In embodiments, performing the processes in the order listed above may reduce the computational costs associated with textual preprocessing and/or improve the accuracy of the resulting root cause taxonomy. However, in embodiments, some of the processes listed above may be omitted, performed in a different sequence, performed simultaneously and/or in parallel with other processes listed above, and/or combined with other processes listed above.

Converting the incident data into a string format, ensures uniformity and compatibility throughout the analysis when the incident data includes different data types, such as, but not limited to, numerical values, categorical variables, and/or the like. Moreover, transforming the incident data into string format enables the inclusion of non-textual information in the analysis, such as, but not limited to, error codes, descriptions, or user feedback, thereby providing a more comprehensive understanding of the incidents and facilitating the identification of root causes. Converting the incident data into a string format also allows for consistent application of text-based techniques and algorithms, such as tokenization, text mining, or natural language processing.

Performing textual cleaning on the incident data ensures that the content is in a clean, and/or standardized format where the meaning of the incident data is consistent throughout the incident data. In embodiments, textual cleaning may include, but is not limited to, removing and/or trimming excess spacing, replacing and/or removing special characters, punctuation marks, and/or symbols, removal of instances of “N/A” and/or other placeholder values, and/or expansion of contractions, such as, but not limited to, “don't” or “can't.” to their full forms (“do not” or “cannot”). These textual cleaning operations prepare the incident data for subsequent data analysis by removing noise in the incident data, and/or normalizing text in the incident data to maintain a consistent meaning in order to facilitate accurate and meaningful root cause identification.

Removing web links and/or addresses in the incident data ensures that subsequent data analysis remains focused on the meaning behind the incident data rather than web links or URLs. In embodiments, web links and/or addresses do not add to the understanding of the incident data, and instead introduces, in most cases, noisy information into the context. In such scenarios, it may be desirable to remove the web links and/or addresses during preprocessing in order to improve the accuracy of root cause identifications.

Replacing text matching specific words, phrase, and/or patterns in the incident data allows for the efficient and systematic modification of text based on specific patterns. In embodiments, text replacement may be performed using regular expressions (regex) in order to provide a flexible and robust way to search for and replace text that matches certain patterns or criteria. By specifying patterns using regex syntax, specific words, phrases, and/or other patterns can be identified and replaced with desired replacement text. For example, in embodiments, it may be desirable to perform complex text transformations, such as, but not limited to, removing, modifying, and/or replacing specific strings, correcting misspellings, standardizing words with alternate spellings, expanding acronyms, and/or standardizing abbreviations. In embodiments, text replacement may be achieved using a dynamic file that contains regex patterns. Text replacement using regex patterns improves the consistency and accuracy in subsequent data analysis steps by removing unwanted elements in the incident data and/or maintaining a consistent meaning for equivalent words, phrases, abbreviations, and/or acronyms across the incident data. This ultimately improves the accuracy of root cause identifications.

Case normalization involves converting all text to a consistent case format, and ensures that the text is standardized and treated uniformly, regardless of the original case variations. In embodiments, case normalization can be performed in different ways, such as converting all text to lowercase or uppercase. This process eliminates discrepancies that may arise from variations in capitalization, and improves the accuracy of text analysis. By applying case normalization, text comparisons, word frequency analysis, and/or other text-based operations become more reliable and consistent.

Preprocessing specific fields in the incident data may involve identifying and rectifying common errors and/or inconsistencies in the text, including, but not limited to, fixing misspelled words, correcting formatting issues, replacing non-standard characters, and/or replacing ambiguous characters. In embodiments, preprocessing the specific fields helps mitigate parsing errors, allowing for smoother text processing and subsequent data analysis. It also ensures that the incident data is in a clean and/or standardized format, thereby enhancing the accuracy and reliability of the root cause identification process.

Replacing underscores in the incident data improves data analysis, and understanding of the underlying content of the incident data by segmenting multiple words separated by underscores into separate words. In embodiments, underscores appear in the incident data in various contexts, such as, for example, using underscores to separate words in variable names, field names, compound words, and/or multi-word phrases. However, in some scenarios, it may be beneficial to treat each word separately in order to improve the understanding of the underlying context. In embodiments, underscores may be replaced with a replacement character, such as, but not limited to, a space. Replacing underscores with spaces segments the text into distinct words, and improves the accuracy of subsequent steps, such as, but not limited to tokenization, part-of-speech tagging, and/or other text transformations.

Standardizing the incident data may include, in embodiments, one or more of text replacement techniques discussed above. After the incident data is standardized, the incident data is further processed by tokenizing the incident data, tagging tokens with parts of speech, removing stop words from the incident data, and/or lemmatizing the incident data. Tokenizing the incident data breaks the incident data into individual words or tokens. In embodiments, part-of-speech tagging may be applied to the incident data to assign grammatical labels to each token. Part-of-speech tagging enables further data analysis based on word types. Subsequently, the incident data may undergo stop word removal where commonly occurring insignificant words, such as, but not limited to, “the,” “or,” and/or “and” are removed. In embodiments, numbers that do not contribute to identifying root causes may be removed from the incident data. Furthermore, in embodiments, the incident data may be lemmatized by reducing words to their base forms. Lemmatization groups together the inflected forms of a word so they can be analyzed as a single item. Lastly, the preprocessed tokens are combined to reconstruct the text in a format that facilitates further data analysis and/or root cause identification.

After the preprocessed tokens have been combined to reconstruct the text, the preprocessed tokens may be analyzed to generate a root cause taxonomy. In embodiments, the incident data may include multiple columns of data, including, but not limited to, preprocessed mitigation cause data, preprocessed mitigation scenario data, other preprocessed mitigation data, preprocessed summary cause data, preprocessed summary scenario data, and/or preprocessed keywords. In embodiments, the column containing other preprocessed mitigation data may act as a catch-all column for additional information that can help complete the analysis. For example, missing data points in the incident data may be replaced or filled in with relevant data, allowing for a more comprehensive and usable dataset.

In embodiments, one or more of the multiple columns of data in the incident data may be combined into one or more combined columns based on their relevancy. For instance, columns containing mitigation data, such as, but not limited to, the columns containing preprocessed mitigation cause data, preprocessed mitigation scenario data, and/or other preprocessed mitigation data may be combined into a combined mitigation column that contains the mitigation data. Similarly, columns containing summary data, such as, but not limited to, the columns containing preprocessed summary cause data, and/or preprocessed summary scenario data may be combined into a combined summary column that contains the summary data. In embodiments, the columns may be further combined by, for example, combining the combined mitigation column, the combined summary column, and/or the preprocessed keywords column into a single combined column. The resulting single combined column may, in embodiments, undergo deduplication to remove duplicate tokens, and/or other further cleaning.

Creation of the hierarchical root cause taxonomy begins with one or more top-level classifications. In embodiments, the top-level classifications may be determined manually through consultation with subject matter experts in the relevant field, and/or automatically created through natural language processing (NLP) methodologies, such as, but not limited to, topic modelling that may be validated by subject matter experts. Additionally, top-level terms may, in embodiments, be determined automatically, semi-automatically, and/or dynamically. For example, automatically generated top-level classifications may be presented to subject matter experts for review and/or approval. In embodiment, each top-level classification may be associated with one or more top-level terms that describe the top-level classification. Similar to top-level classifications, top-level terms may also be determined manually, automatically, semi-automatically, and/or dynamically through consultation with subject matter experts in the relevant field. For example, automatically generated top-level terms may be presented to subject matter experts for review and/or approval.

After the top-level classifications and/or top-level terms have been established, the processed incident data is analyzed based on the top-level classifications and/or top-level terms to extract lower level (e.g., second-level, third-level, nth-level, etc.) classifications. The processed incident data is analyzed to extract patterns in the incident data. By analyzing patterns within the data, such as, but not limited to, common themes, relationships, and/or dependencies, it becomes possible to establish a hierarchical structure for the top-level classifications. In embodiments, the preprocessed data is analyzed to determine second-level terms that have a high frequency of cooccurrence with top-level term(s) associated with a top-level classification. A second-level classification is generated based on the terms having the highest frequencies of cooccurrence with the top-level term(s), and added to the hierarchical root cause taxonomy as a child to the top-level classification. In embodiments, the second-level term(s) may be determined based on the terms having a cooccurrence frequency with the top-level term(s) that satisfies a first predetermined relationship (e.g., greater than, greater than or equal to, etc.) with a first frequency threshold. In embodiments, the first frequency threshold may include, but is not limited to, a numerical frequency value (e.g., terms higher than a minimum cooccurrence frequency), a rank value (e.g., top 3 terms with the highest cooccurrence frequencies), and/or a combination thereof (e.g., two terms having the higher cooccurrence frequencies above a minimum cooccurrence frequency). This process may be repeated for each top-level classification and their respective top-level terms to generate one or more second-level classifications. However, in embodiments, top-level classifications may include zero, one, or more second-level classifications as children.

In embodiments, subsequent levels in the hierarchy may be established in a similar manner. For instance, a third-level classification may be established based on third-level terms that have a high frequency of cooccurrence with second-level term(s) and/or top-level term(s) associated with a second-level classification and/or its parent top-level classification, respectively, and added to the hierarchical root cause taxonomy as a child to the second-level classification. In embodiments, the third-level term(s) may be determined based on the terms having a cooccurrence frequency with the second-level term(s) and/or top-level term(s) that satisfies a second predetermined relationship (e.g., greater than, greater than or equal to, etc.) with a second frequency threshold. In embodiments, the second frequency threshold may include, but is not limited to, a numerical frequency value (e.g., terms higher than a minimum cooccurrence frequency), a rank value (e.g., top 3 terms with the highest cooccurrence frequencies), and/or a combination thereof (e.g., two terms having the higher cooccurrence frequencies above a minimum cooccurrence frequency). This process may be repeated for each second-level classification and their respective top-level terms to generate one or more third-level classifications. However, in embodiments, second-level classifications may include zero, one, or more second-level classifications as children.

Additional lower level (e.g., fourth-level, fifth-level, nth-level, etc.) classifications may be established in a similar manner based on term(s) associated with one or more higher level classifications in the hierarchical root cause taxonomy. In embodiments, the depth of the hierarchical root cause taxonomy may be determined based on the amount and/or quality of the available incident data. For instance, the availability of large amounts of accurate and detailed incident data may allow for the generation of additional levels in the hierarchical root cause taxonomy. Additionally, in embodiments, the depth of the hierarchical root cause taxonomy may be the same or different for each branch of the root cause taxonomy associated with each top-level classification.

The resulting root cause taxonomy hierarchy allows for a deeper understanding of the underlying factors contributing to incidents. By defining multiple levels within the root cause taxonomy hierarchy, it becomes possible to categorize and prioritize the causes based on their level of impact and/or specificity. The embodiments disclosed herein provide a structured framework for organizing, identifying, and/or labeling root causes, enabling more effective incident resolution and prevention strategies. This facilitates the identification of not only immediate causes but also underlying factors that can help mitigate similar incidents in the future.

These and further embodiments are disclosed herein that enable the functionality described above and further such functionality. Such embodiments are described in further detail as follows.

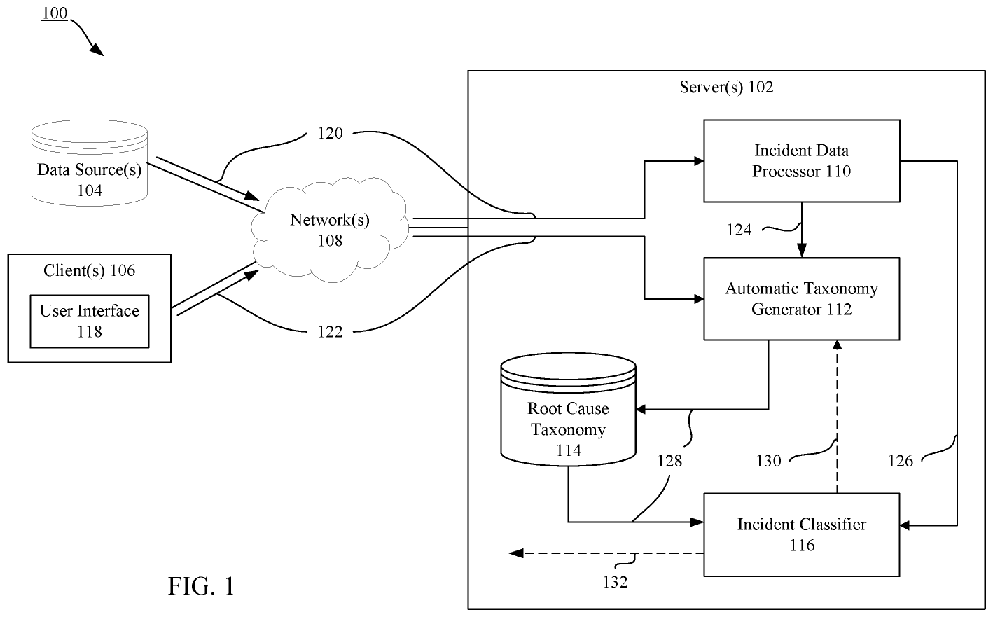

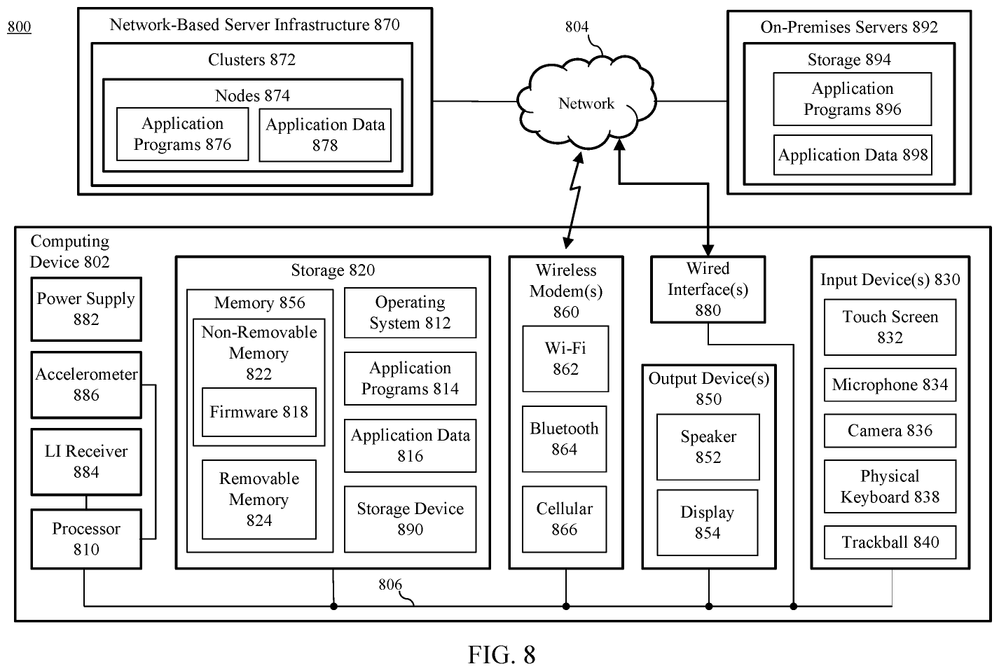

For instance, FIG. 1 shows a block diagram of an example system 100 for generating a root cause taxonomy, in accordance with an embodiment. As shown in FIG. 1, system 100 includes one or more servers 102, one or more data sources 104, and one or more clients 106. Server(s) 102, data source(s) 104, and client(s) 106 are communicatively coupled to each other via one or more networks 108. Network 108 may comprise one or more networks such as local area networks (LANs), wide area networks (WANs), enterprise networks, the Internet, etc., and may include one or more wired and/or wireless portions. Various example implementations of network(s) 108 are described below in reference to FIG. 8 (e.g., Network 804). System 100 is described in further detail as follows.

Server(s) 102 may include any computing device suitable for performing functions that are ascribed thereto in the following description, as will be appreciated by persons skilled in the relevant art(s), including those mentioned elsewhere herein or otherwise known. Various example implementations of server(s) 102 are described below in reference to FIG. 8 (e.g., computing device 802, network-based server infrastructure 870, and/or on-premises servers 892). As shown in FIG. 1, server(s) 102 includes an incident data processor 110, an automatic taxonomy generator 112, a root cause taxonomy storage 114, and an incident classifier 116.

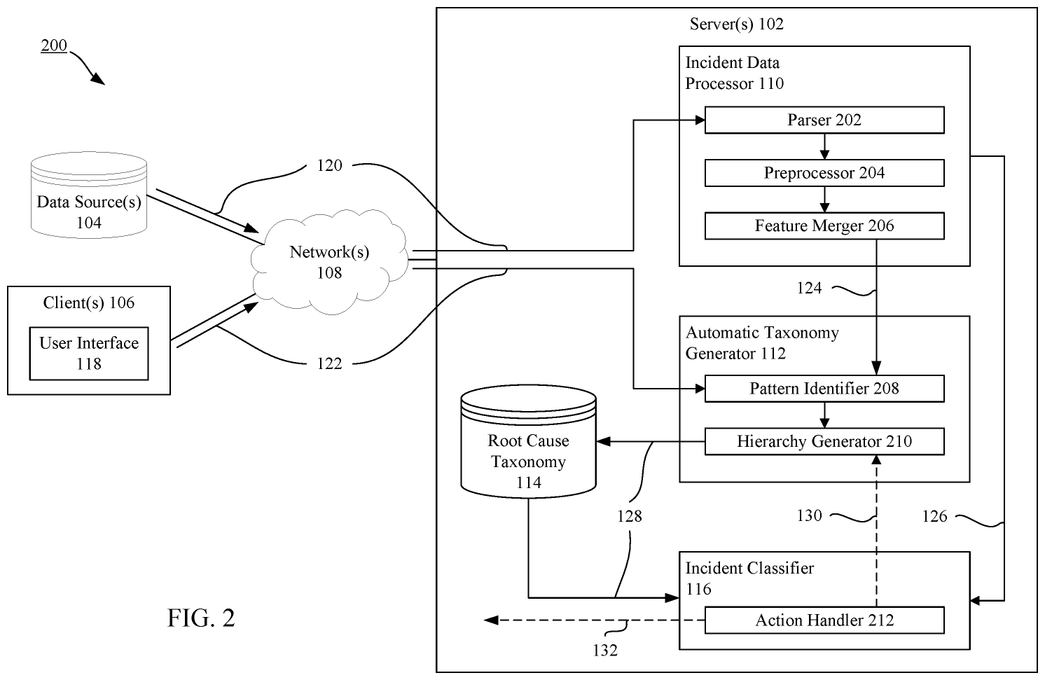

Incident data processor 110 is configured to access incident data 120 stored on data source(s) 104, and process incident data 120 to produce processed incident data 124. In embodiments, processing performed by incident data processor 110 may include, but is not limited to, parsing incident data 120, preprocessing incident data 120, and/or merging features in incident data 120. As discussed above, textual preprocessing of incident data 120 may include, but not limited to, one or more of the following: converting incident data 120 into a string format; perform textual cleaning of incident data 120; removing web links and/or addresses from incident data 120; replacing text matching specific words, phrase, and/or patterns in incident data 120; perform case normalization on incident data 120; preprocessing specific fields in incident data 120; remove excess spaces in incident data 120; remove placeholder text in incident data 120; replacing underscores in incident data 120; tokenizing incident data 120; removing stop words from incident data 120; and/or lemmatizing incident data 120. Incident data processor 110 may provide processed incident data 124 to automatic taxonomy generator 112. In embodiments, incident data processor 110 may also provide incident data 120, processed incident data 124, and/or portions thereof to incident classifier 116 as unclassified incident data 126. Incident data processor 110 will be described in greater detail below in conjunction with FIG. 2.

Automatic taxonomy generator 112 is configured to receive processed incident data 124 from incident data processor 110 and one or more top-level classifications 122 from client(s) 106, and generate a root cause taxonomy 128 based on top-level classification(s) 122 and processed incident data 124. As discussed above, generation of root cause taxonomy 128 begins by analyzing processed incident data 124 based on top-level classification(s) 122, and/or one or more top-level terms associated therewith, to extract lower level (e.g., second-level, third-level, nth-level, etc.) classifications. For example, processed incident data 124 is analyzed to extract patterns such as, but not limited to, common themes, relationships, and/or dependencies in processed incident data 124. In embodiments, preprocessed data 124 may be is analyzed to determine second-level terms that have a high frequency of cooccurrence with top-level term(s) associated with top-level classification(s) 122. One or more second-level classifications may be generated based on the terms having the highest frequencies of cooccurrence with the top-level term(s), and added to the root cause taxonomy 128 as a child to top-level classification(s) 122. In embodiments, the second-level term(s) may be determined based on the terms having a cooccurrence frequency with the top-level term(s) that satisfies a first predetermined relationship (e.g., greater than, greater than or equal to, etc.) with a first frequency threshold. Subsequent levels in the hierarchy may be established in a similar manner. For instance, a third-level classification may be generated based on terms that have a high frequency of cooccurrence with the second-level term(s) and/or top-level term(s) associated with a second-level classification and/or its parent top-level classification, respectively, and added to root cause taxonomy 128 as a child to the second-level classification. In embodiments, the third-level term(s) may be determined based on the terms having a cooccurrence frequency with the second-level term(s) and/or top-level term(s) that satisfies a second predetermined relationship (e.g., greater than, greater than or equal to, etc.) with a second frequency threshold. In embodiments, additional lower level (e.g., fourth-level, fifth-level, nth-level, etc.) classifications may be generated for root cause taxonomy 128 in a similar manner based on term(s) associated with one or more higher level classifications in the hierarchical root cause taxonomy. In embodiments, the depth of the hierarchical root cause taxonomy may be determined based on the amount and/or quality of the available incident data. For instance, the availability of large amounts of accurate and detailed incident data may allow for the generation of additional levels in the hierarchical root cause taxonomy.

In embodiments, automatic taxonomy generator 112 may provide root cause taxonomy 128 to root cause taxonomy storage 114 for storage. Additionally or alternatively, automatic taxonomy generator 112 may, in embodiments, provide root cause taxonomy 128 directly to incident classifier 116. Automatic taxonomy generator 112 will be described in greater detail below in conjunction with FIG. 2.

Root cause taxonomy storage 114 is configured to store root cause taxonomy 128. and provide root cause taxonomy 128 to incident classifier 116 to enable incident classifier 116 to classify unclassified incident data 126 based on root cause taxonomy 128. Various example implementations of root cause taxonomy storage 114 are described below in reference to FIG. 8 (e.g., Storage 820 and/or components thereof). In embodiments, root cause taxonomy storage 114 may be omitted completely, and automatic taxonomy generator 112 may provide root cause taxonomy 128 directly to incident classifier 116.

Incident classifier 116 is configured to classify unclassified incident data 126 based on root cause taxonomy 128 to generate one or more incident classifications 130. For instance, each incident in unclassified incident data 126 may be assigned the most relevant category within the hierarchy of root cause taxonomy 128. The hierarchical arrangement of root cause taxonomy 128 enables efficient and intuitive classification, and facilitates understanding of relationships between different classifications in the hierarchy. In embodiments, incident classifier 116 may employ one or more artificial intelligence (AI) and/or machine learning (ML) classification models (not shown) to assign incidents in unclassified incident data 126 to a classification of root cause taxonomy 128. AI/ML classification models are machine learning algorithms designed to categorize input data (e.g., unclassified incident data 126) into predefined classifications (e.g., a classification of root cause taxonomy 128). In embodiments, AI/ML classification models learn patterns and relationships from training data (e.g., manually and/or automatically labeled incident data) to make predictions on new, unlabeled data (e.g., unclassified incident data 126). Various algorithms, such as, but not limited to, logistic regression, decision trees, support vector machines, and neural networks, can be employed to build AI/ML classification models. In embodiments, incident classifier 116 may provide incident classification(s) 130 as feedback to automatic taxonomy generator 112 in order to update and/or improve root cause taxonomy 128. In embodiments, incident classifier 116 may also output an incident trigger 132 to cause one or more elements of system 100 and/or components thereof to perform an action, such as, but not limited to, providing a notification to a user (e.g., an administrator), providing a recommendation to a user (e.g., an administrator), and/or automatically performing a remedial action to remediate the incident. Incident classifier 116 will be described in greater detail below in conjunction with FIG. 2.

Data source(s) 104 may include any storage device suitable for storing incident data 120 and making incident data 120 available to server(s) 102 and/or client(s) 106. In embodiments, data source(s) 104 may represent various sources, such as, but not limited to, log files, monitoring systems, user reports, and/or automated alerts. Furthermore, data source(s) 104 may store incident data 120, such as, but not limited to, information associated with events, anomalies, and/or disruptions, and can include details such as, but not limited to, timestamps, event descriptions, affected entities, severity levels, associated error codes, and/or any relevant contextual information.

While data source(s) 104 are depicted in FIGS. 1 and 2 as connected to network(s) 108, in embodiments, data source(s) 104 may be accessible to server(s) 102 and/or client(s) 106 through other means, including, but not limited to, via a computer bus (e.g., Serial ATA, PCIe, Thunderbolt, USB, eSATA, etc.), and/or via removable storage media (e.g., portable storage device, optical disc, memory card, etc.). Various example implementations of data source(s) 104 are described below in reference to FIG. 8 (e.g., Storage 820 and/or components thereof).

Client(s) 106 may each be any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. In embodiments, client(s) 106 may include any computing device suitable for performing functions that are ascribed thereto in the following description, as will be appreciated by persons skilled in the relevant art(s), including those mentioned elsewhere herein or otherwise known. Various example implementations of client(s) 106 are described below in reference to FIG. 8 (e.g., computing device 802).

As shown in FIG. 1, client(s) 106 may include a user interface (UI) 118. Users of client(s) 106 may utilize UI 118 to access applications and/or services of server(s) 102 and/or incident data 120 stored on data source(s) 104. In embodiments, client(s) 106 may be employed by a user (e.g., a subject matter expert) to provide top-level classification(s) 122 to automatic taxonomy generator 112.

Embodiments described herein may operate in various ways to generate a hierarchical root cause taxonomy. For instance, FIG. 2 shows a block diagram of an example system 200 for generating an hierarchical root cause taxonomy, in accordance with an embodiment. As shown in FIG. 2, system 200 includes server(s) 102, data source(s) 104, client(s) 106, network(s) 108, incident data processor 110, automatic taxonomy generator 112, root cause taxonomy storage 114, incident classifier 116, and UI 118, as shown in FIG. 1. In system 200, incident data processor 110 further includes a parser 202, a preprocessor 204, and a feature merger 206. Furthermore, automatic taxonomy generator 112 further includes a pattern identifier 208, and a hierarchy generator 210. Additionally, incident classifier 116 further includes an action handler 212. System 200 is described in further detail as follows.

Parser 202 is configured to analyze and/or extract information from unstructured and/or semi-structured data (e.g., incident data 120). In embodiments, parser 202 may receive incident data 120 from client(s) 106 and apply parsing techniques to identify details like timestamps, event types, affected systems, error codes, and/or other contextual information associated with incident data 120. By converting raw data into a structured format, parser 202 facilitates efficient storage, and analysis of incident data 120. In embodiments, parser 202 may provide the parsed incident data to preprocessor 204 for preprocessing.

Preprocessor 204 is configured to receive parsed incident data from parser 202, and perform textual preprocessing of the parsed incident data into a clean and/or standardized format to facilitate further analysis on the incident data. As discussed above, textual preprocessing may include, but is not limited to, one or more of the following converting the parsed incident data into a string format; perform textual cleaning of the parsed incident data; removing web links and/or addresses from the parsed incident data; remove excess spaces in the parsed incident data; remove placeholder text in the parsed incident data; replacing text matching specific words, phrase, and/or patterns in the parsed incident data; perform case normalization on the parsed incident data; preprocessing specific fields in the parsed incident data; replacing underscores in the parsed incident data; tokenizing the parsed incident data; removing stop words from the parsed incident data; and/or lemmatizing the parsed incident data. Textual preprocessing performed by preprocessor 204 may result in a tokenized incident data that is representative of the parsed incident data. In embodiments, preprocessor 204 may provide the resulting tokenized incident data to feature merger 206.

Feature merger 206 is configured to merge features in tokenized incident data, and/or perform deduplication on the merged features. As discussed above, the tokenized incident data may include multiple columns of data, including, but not limited to, preprocessed mitigation cause data, preprocessed mitigation scenario data, other preprocessed mitigation data, preprocessed summary cause data, preprocessed summary scenario data, and/or preprocessed keywords. In embodiments, feature merger 206 may combine one or more of the multiple columns of data in the tokenized incident data based on their relevancy. For instance, columns containing mitigation data, such as, but not limited to, columns containing preprocessed mitigation cause data, preprocessed mitigation scenario data, and/or other preprocessed mitigation data may be combined into a combined mitigation column that contains the mitigation data. Similarly, the columns containing summary data, such as, but not limited to, the columns containing preprocessed summary cause data, and/or preprocessed summary scenario data may be combined into a combined summary column that contains the summary data. In embodiments, the columns may be further combined by, for example, combining the combined mitigation column, the combined summary column, and/or the preprocessed keywords column into a single combined column. In embodiments, feature merger 206 may perform further operations, including, but not limited to, deduplication to remove duplicate tokens, and/or other further cleaning. Feature merger 206 may provide the merged features as processed incident data 124 to pattern identifier 208 of automatic taxonomy generator 112 for further analysis.

Pattern identifier 208 is configured to identify and extract patterns in processed incident data 124 based on top-level classification(s) 122. In embodiments, pattern identifier 208 may be configured to receive processed incident data 124 from feature merger 206 of incident data processor 110, receive top-level classification(s) 122 from client(s) 106, and identify patterns in processed incident data 124 based on top-level classification(s) 122. As discussed above, generation of root cause taxonomy 128 begins by analyzing processed incident data 128 based on top-level classification(s) 122, and/or one or more top-level terms associated therewith, to extract lower level (e.g., second-level, third-level, nth-level, etc.) classifications. For example, pattern identifier 208 may analyze processed incident data 124 to determine second-level terms that have a high frequency of cooccurrence with top-level term(s) associated with top-level classification(s) 122. In embodiments, pattern identifier 208 may identify second-level term(s) based on terms that have a cooccurrence frequency with the top-level term(s) that satisfies a first predetermined relationship (e.g., greater than, greater than or equal to, etc.) with a first frequency threshold. Similarly, pattern identifier 208 may analyze processed incident data 124 to determine third-level terms that have a high frequency of cooccurrence with the second-level term(s) and/or top-level term(s) associated with a second-level classification and/or its parent top-level classification, respectively. In embodiments, pattern identifier 208 may identify third-level term(s) based on terms that have a cooccurrence frequency with the second-level term(s) and/or top-level term(s) that satisfies a second predetermined relationship (e.g., greater than, greater than or equal to, etc.) with a second frequency threshold. In embodiments, pattern identifier 208 may identify terms for additional lower level (e.g., fourth-level, fifth-level, nth-level, etc.) classifications in a similar manner based on a frequency of cooccurrence term(s) associated with one or more higher level classifications. Pattern identifier 208 may provide the identified second-level, third-level, and/or subsequent lower level term(s) to hierarchy generator 210.

Hierarchy generator 210 is configured to generate a hierarchical root cause taxonomy based on patterns identified by pattern identifier 208. For instance, one or more second-level classifications may be generated based on the terms having the highest frequencies of cooccurrence with the top-level term(s), and added to the root cause taxonomy 128 as a child to top-level classification(s) 122. Similarly, one or more third-level classifications may be generated based on terms that have a high frequency of cooccurrence with the second-level term(s) and/or top-level term(s) associated with a second-level classification and/or its parent top-level classification, respectively, and added to root cause taxonomy 128 as a child to the second-level classification. Subsequent lower level classifications may be generated for root cause taxonomy 128 in a similar manner based on term(s) associated with one or more higher level classifications in the hierarchical root cause taxonomy. Hierarchy generator 210 may provide the resulting root cause taxonomy 128 to root cause taxonomy storage 114 for storage.

Action handler 212 is configured to perform one or more actions based on incident classifications determined by incident classifier 116. For example, actions performed by action handler 212 may include, but are not limited to, providing a notification based on the incident classification, providing a recommendation based on the incident classification, providing descriptive statistics based on the incident classification, providing prioritization guidance based on the incident classification, automatically performing a remedial action based on the incident classification, and/or providing incident classification 130 to hierarchy generator 210 to update the root cause taxonomy based on incident classification 130. In embodiments, action handler 212 may output an incident trigger 132 (e.g., message, command, instruction, etc.) to trigger performance of the action.

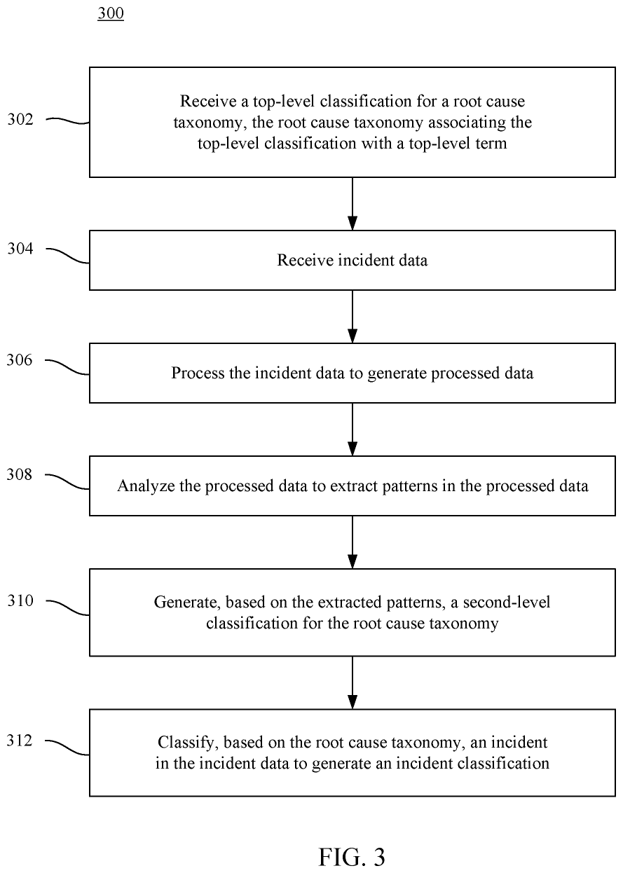

Embodiments described herein may operate in various ways to generate a root cause taxonomy. For instance, FIG. 3 depicts a flowchart 300 of a process for generating a root cause taxonomy, in accordance with an embodiment. Server(s) 102, incident data processor 110, automatic taxonomy generator 112, root cause taxonomy storage 114, incident classifier 116, parser 202, preprocessor 204, feature merger 206, pattern identifier 208. hierarchy generator 210, and/or action handler 212 of FIGS. 1 and/or 2 may operate according to flowchart 300, for example. Note that not all steps of flowchart 300 may need to be performed in all embodiments, and in some embodiments, the steps of flowchart 300 may be performed in different orders than shown. Flowchart 300 is described as follows with respect to FIGS. 1 and 2 for illustrative purposes.

Flowchart 300 starts at step 302. In step 302, a top-level classification is received for a root cause taxonomy, the root cause taxonomy associating the top-level classification with a top-level term. For example, pattern identifier 208 of automatic taxonomy generator may receive top-level classification(s) 122 from client(s) 106 via UI 118.

In step 304, incident data is received. For example, parser 202 of incident data processor 110 may receive incident data 120 from data source(s) 104.

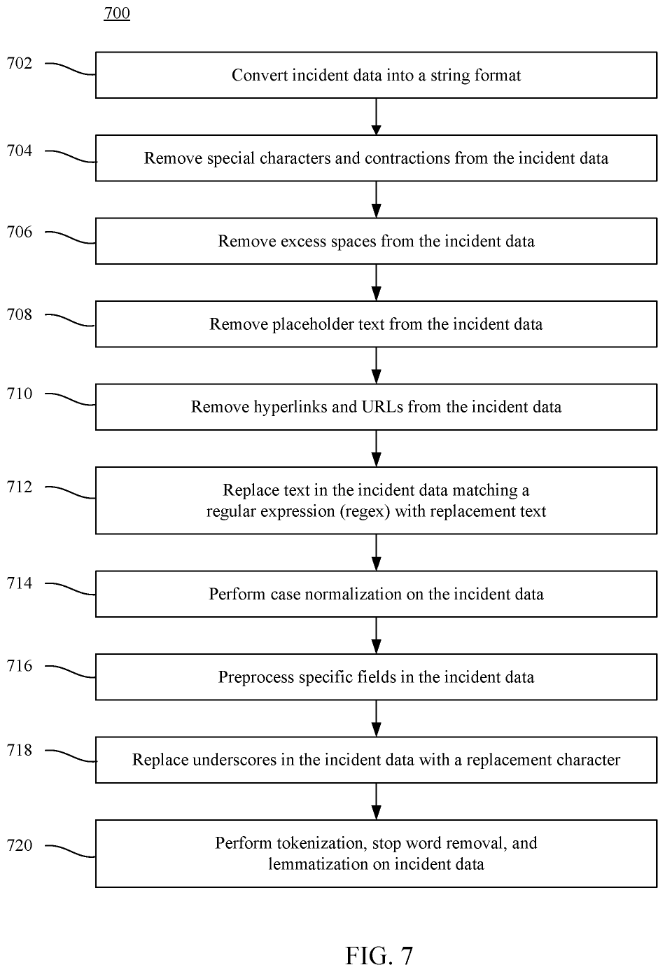

In step 306, the incident data is processed to generate processed data. For example, parser 202, preprocessor 204, and/or feature merger 206 of incident processor 110 may process incident data 120 to produce processed incident data 124. As discussed above, processing of incident data 120 may include, but is not limited to, parsing incident data 120, converting the parsed incident data into a string format; perform textual cleaning of the parsed incident data; removing excess spaces from the parsed incident data; remove placeholder text from the parsed incident data; removing web links and/or addresses from the parsed incident data; replacing text matching specific words, phrase, and/or patterns in the parsed incident data; perform case normalization on the parsed incident data; preprocessing specific fields in the parsed incident data; replacing underscores in the parsed incident data; tokenizing the parsed incident data; removing stop words from the parsed incident data; lemmatizing the parsed incident data; feature merging of tokenized incident data; and/or deduplication of merged tokenized incident data. In embodiments, feature merger 206 of incident processor 110 may provide resulting processed incident data 124 to pattern identifier 208 of automatic taxonomy generator 112 for analysis. Step 306 will be discussed in greater detail below in conjunction with FIG. 7.

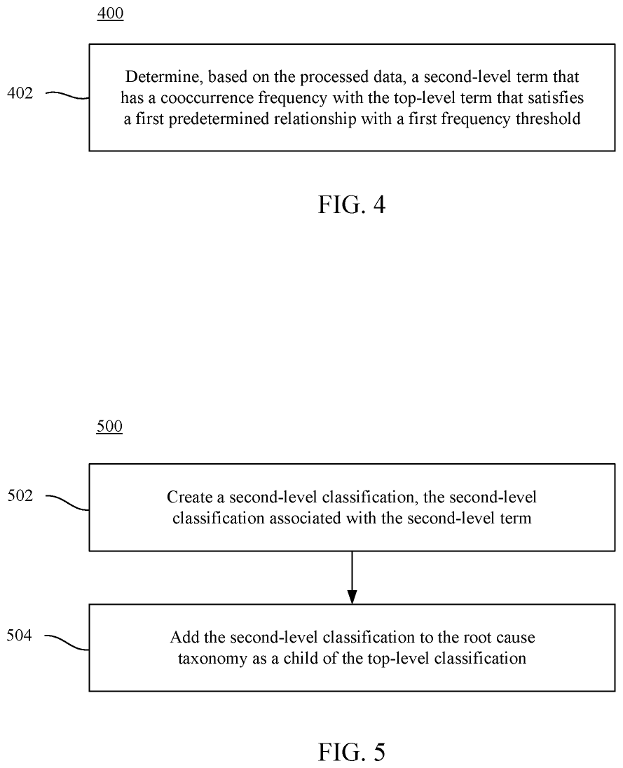

In step 308, the processed data is analyzed to extract patterns in the processed data. For example, pattern identifier 208 of automatic taxonomy generator 112 may analyze processed incident data 124 to identify and extract patterns in processed incident data 124. As discussed above, pattern identifier 208 may be configured to identify patterns in processed incident data 124 based on the cooccurrence frequency of terms with top-level term(s) associated with top-level classification(s) 122. Step 308 will be discussed in greater detail below in conjunction with FIG. 4.

In step 310, a second-level classification is generated for the root cause taxonomy based on the extracted patterns. For example, hierarchy generator 210 of automatic taxonomy generator 112 may generate a second-level classification for root cause taxonomy 128 based on patterns extracted from processed incident data 124 by pattern identifier 208. Step 310 is discussed in greater detail below in conjunction with FIG. 5.

In step 312, an incident in the incident data is classified based on the root cause taxonomy to generate an incident classification. For example, incident classifier 116 and/or a component thereof, may classify an incident in unclassified incident data 126 based on root cause taxonomy 128. As discussed above, in embodiments, incident classifier 116 may employ one or more artificial intelligence (AI) and/or machine learning (ML) classification models to assign incidents in unclassified incident data 126 to a classification of root cause taxonomy 128.

Embodiments described herein may operate in various ways to identify patterns in incident data. For instance, FIG. 4 depicts a flowchart 400 of a process for identifying patterns in incident data, in accordance with an embodiment. Server(s) 102, automatic taxonomy generator 112, and/or pattern identifier 208 of FIGS. 1 and/or 2 may operate according to flowchart 400, for example. Flowchart 400 is described as follows with respect to FIGS. 1 and 2 for illustrative purposes.

Flowchart 400 starts at step 402. In step 402, a second-level term that has a cooccurrence frequency with the top-level term that satisfies a first predetermined relationship with a first frequency threshold is determined based on the processed data. For example, pattern identifier 208 may analyze processed incident data 124 to determine second-level terms that have a high frequency of cooccurrence with top-level term(s) associated with top-level classification(s) 122. In embodiments, pattern identifier 208 may identify second-level term(s) based on terms that have a cooccurrence frequency with the top-level term(s) that satisfies a first predetermined relationship (e.g., greater than, greater than or equal to, etc.) with a first frequency threshold.

Embodiments described herein may operate in various ways to generate hierarchical classifications based on patterns identified in incident data. For instance, FIG. 5 depicts a flowchart 500 of a process generating hierarchical classifications based on patterns identified in incident data, in accordance with an embodiment. Server(s) 102, automatic taxonomy generator 112, and/or hierarchy generator 210 of FIGS. 1 and/or 2 may operate according to flowchart 500, for example. Note that not all steps of flowchart 500 may need to be performed in all embodiments. Flowchart 500 is described as follows with respect to FIGS. 1 and 2 for illustrative purposes.

Flowchart 500 starts at step 502. In step 502, a second-level classification is created, the second-level classification associated with the second-level term. For example, hierarchy generator 210 of automatic taxonomy generator 112 may generate one or more second-level classifications based on the terms having the highest frequencies of cooccurrence with the top-level term(s) associated with a top-level classification 122.

In step 504, the second-level classification is added to the root cause taxonomy as a child of the top-level classification. For example, hierarchy generator 210 of automatic taxonomy generator 112 may add the generated second-level classification to root cause taxonomy 128 as a child to the top-level classification 122.

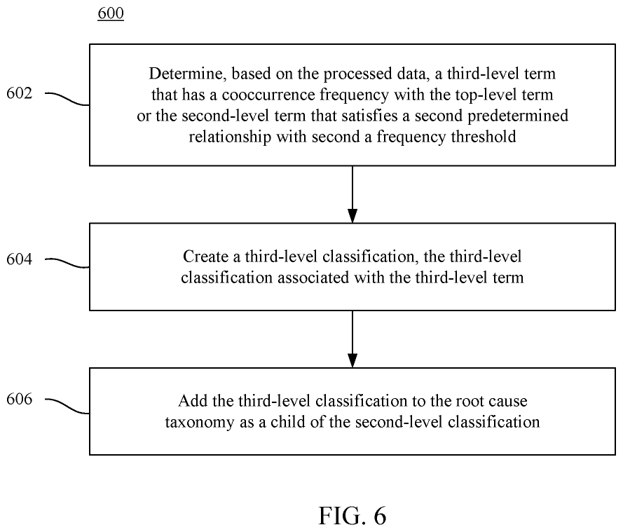

Embodiments described herein may operate in various ways to generate hierarchical classifications based on patterns identified in incident data. For instance, FIG. 6 depicts a flowchart 600 of a process for generating hierarchical classifications based on patterns identified in incident data, in accordance with an embodiment. Server(s) 102, automatic taxonomy generator 112, pattern identifier 208, and/or hierarchy generator 210 of FIGS. 1 and/or 2 may operate according to flowchart 600, for example. Note that not all steps of flowchart 600 may need to be performed in all embodiments, and in some embodiments, the steps of flowchart 600 may be performed in different orders than shown. Flowchart 600 is described as follows with respect to FIGS. 1 and 2 for illustrative purposes.

Flowchart 600 starts at step 602. In step 602, a third-level term that has a cooccurrence frequency with the top-level term or the second-level term that satisfies a second predetermined relationship with a second frequency threshold is determined based on the processed data. For example, pattern identifier 208 may analyze processed incident data 124 to determine third-level terms that have a high frequency of cooccurrence with the second-level term(s) and/or top-level term(s) associated with a second-level classification and/or its parent top-level classification, respectively. In embodiments, pattern identifier 208 may identify third-level term(s) based on terms that have a cooccurrence frequency with the second-level term(s) and/or top-level term(s) that satisfies a second predetermined relationship (e.g., greater than, greater than or equal to, etc.) with a second frequency threshold.

In step 604, a third-level classification is created, the third-level classification associated with the third-level term. For example, hierarchy generator 210 of automatic taxonomy generator 112 may generate one or more third-level classifications based on the terms having the highest frequencies of cooccurrence with the second-level term(s) and/or top-level term(s) associated with a second-level classification and/or its parent top-level classification, respectively.

In step 606, the third-level classification is added to the root cause taxonomy as a child of the second-level classification. For example, hierarchy generator 210 of automatic taxonomy generator 112 may add the generated third-level classification to root cause taxonomy 128 as a child to the second-level classification.

Embodiments described herein may operate in various ways to preprocess incident data. For instance, FIG. 7 depicts a flowchart 700 of a process for preprocessing incident data, in accordance with an embodiment. Server(s) 102, incident data processor 110, parser 202, preprocessor 204, and/or feature merger 206 of FIGS. 1 and/or 2 may operate according to flowchart 700, for example. Note that not all steps of flowchart 700 may need to be performed in all embodiments, and in some embodiments, the steps of flowchart 700 may be performed in different orders than shown. Flowchart 700 is described as follows with respect to FIGS. 1 and 2 for illustrative purposes.

Flowchart 700 starts at step 702. In step 702, incident data is converted into a string format. For example, preprocessor 204 may convert incident data 120 into a string format. As discussed above, converting incident data 120 into a string format ensures uniformity and compatibility throughout the analysis when the incident data includes different data types. Moreover, converting incident data 120 into string format enables the inclusion of non-textual information in the analysis, such as, but not limited to, error codes, descriptions, or user feedback, thereby providing a more comprehensive understanding of the incidents and facilitating the identification of root causes. Converting incident data 120 into a string format also allows for consistent application of text-based techniques and algorithms, such as tokenization, text mining, or natural language processing.

In step 704, special characters and contractions are removed from the incident data. For example, preprocessor 204 may remove special characters and contractions from incident data 120. As discussed above, removing special characters and contractions removes noise from the incident data and normalizes text in the incident data to maintain a consistent meaning in order to facilitate accurate and meaningful root cause identification.

In step 706, excess spaces are removed from the incident data. For example, preprocessor 204 may remove excess spaces from incident data 120. As discussed above, removing excess spaces removes noise from the incident data and normalizes text in the incident data to maintain a consistent meaning in order to facilitate accurate and meaningful root cause identification.

In step 708, placeholder text is removed from the incident data. For example, preprocessor 204 may remove placeholder text from incident data 120. As discussed above, removing placeholder text removes noise from the incident data and normalizes text in the incident data to maintain a consistent meaning in order to facilitate accurate and meaningful root cause identification.

In step 710, hyperlinks and URLs are removed from the incident data. For example, preprocessor 204 may remove hyperlinks and/or URLs from incident data 120. As discussed above, removing web links and/or addresses in the incident data ensures that subsequent data analysis remains focused on the meaning behind the incident data rather than web links or URLs. In embodiments, web links and/or addresses do not add to the understanding of the incident data. In such scenarios, it may be desirable to remove the web links and/or addresses during preprocessing in order to improve the accuracy of root cause identifications.

In step 712, text in the incident data matching a regular expression (regex) is replaced with replacement text. For example, preprocessor 204 may replace text in incident data 120 matching a regex pattern with replacement text. As discussed above, text replacement using regex patterns improves the consistency and accuracy in subsequent data analysis steps by removing unwanted elements in the incident data and/or maintaining a consistent meaning for equivalent words, phrases, abbreviations, and/or acronyms across the incident data.

In step 714, case normalization is performed on the incident data. For example, preprocessor 204 may perform case normalization on incident data 120. As discussed above, case normalization may include converting all text to a consistent case format, such as upper case or lower case. Case normalization helps ensure that the text is standardized and treated uniformly, thereby eliminating potential discrepancies that may arise from variations in capitalization and improving the accuracy of text analysis.

In step 716, specific fields in the incident data are preprocessed. For example, preprocessor 204 may preprocess specific fields in incident data 120. As discussed above, preprocessing specific fields in the incident data 120 may involve identifying and rectifying common errors and/or inconsistencies in the text, including, but not limited to, fixing misspelled words, correcting formatting issues, replacing non-standard characters, and/or replacing ambiguous characters. Preprocessing specific fields helps mitigate parsing errors, allowing for smoother text processing and subsequent data analysis, and ensures that the incident data is in a clean and/or standardized format.

In step 718, underscores in the incident data are replaced with a replacement character. For example, preprocessor 204 may replace underscores in incident data 120 with a replacement character (e.g., a space). As discussed above, replacing underscores in the incident data improves data analysis, and understanding of the underlying content of the incident data by segmenting multiple words separated by underscores into separate words. In particular, replacing underscores with spaces segments the text into distinct words, and improves the accuracy of subsequent steps, such as, but not limited to tokenization, part-of-speech tagging, and/or other text transformations.

In step 720, tokenization, stop word removal, and lemmatization are performed on the incident data. For example, preprocessor 204 may perform tokenization, stop word removal, and lemmatization on the incident data 120. As discussed above, tokenizing incident data 120 breaks incident data 120 into individual words or tokens. In embodiments, part-of-speech tagging may be applied to the incident data to assign grammatical labels to each token. Stop word removal removes commonly occurring insignificant words, such as, but not limited to, “the,” “or,” and/or “and” from incident data 120. Lemmatization groups together the inflected forms of a word so they can be analyzed as a single item.

### III. Example Mobile Device and Computer System Implementation

The systems, methods, and computer-readable storage devices described above in reference to FIGS. 1-7, server(s) 102, data source(s) 104, client(s) 106, network(s) 108, incident data processor 110, automatic taxonomy generator 112, root cause taxonomy storage 114, incident classifier 116, parser 202, preprocessor 204, feature merger 206, pattern identifier 208, hierarchy generator 210, action handler 212, and/or each of the components described therein, and/or the steps of flowcharts 300, 400, 500, 600, and/or 700 may be each implemented as computer program code/instructions configured to be executed in one or more processors and stored in a computer readable storage medium. For example, incident data processor 110, automatic taxonomy generator 112, root cause taxonomy storage 114, incident classifier 116, parser 202, preprocessor 204, feature merger 206, pattern identifier 208, hierarchy generator 210, action handler 212, and/or each of the components described therein, and/or the steps of flowcharts 300, 400, 500, 600, and/or 700 may be each implemented as computer program code/instructions configured to be executed in one or more processors and stored in a computer readable storage medium. Alternatively, incident data processor 110, automatic taxonomy generator 112, root cause taxonomy storage 114, incident classifier 116, parser 202, preprocessor 204, feature merger 206, pattern identifier 208, hierarchy generator 210, action handler 212, and/or each of the components described therein, and/or the steps of flowcharts 300, 400, 500, 600, and/or 700 may be implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 8. FIG. 8 shows a block diagram of an exemplary computing environment 800 that includes a computing device 802. In some embodiments, computing device 802 is communicatively coupled with devices (not shown in FIG. 8) external to computing environment 800 via network 804. Network 804 comprises one or more networks such as local area networks (LANs), wide area networks (WANs), enterprise networks, the Internet, etc., and may include one or more wired and/or wireless portions. Network 804 may additionally or alternatively include a cellular network for cellular communications. Computing device 802 is described in detail as follows

Computing device 802 can be any of a variety of types of computing devices. For example, computing device 802 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Quest 2® by Reality Labs, a division of Meta Platforms, Inc, etc.), or other type of mobile computing device. Computing device 802 may alternatively be a stationary computing device such as a desktop computer, a personal computer (PC), a stationary server device, a minicomputer, a mainframe, a supercomputer, etc.

As shown in FIG. 8, computing device 802 includes a variety of hardware and software components, including a processor 810, a storage 820, one or more input devices 830, one or more output devices 850, one or more wireless modems 860, one or more wired interfaces 880, a power supply 882, a location information (LI) receiver 884, and an accelerometer 886. Storage 820 includes memory 856, which includes non-removable memory 822 and removable memory 824, and a storage device 890. Storage 820 also stores an operating system 812, application programs 814, and application data 816. Wireless modem(s) 860 include a Wi-Fi modem 862, a Bluetooth modem 864, and a cellular modem 866. Output device(s) 850 includes a speaker 852 and a display 854. Input device(s) 830 includes a touch screen 832, a microphone 834, a camera 836, a physical keyboard 838, and a trackball 840. Not all components of computing device 802 shown in FIG. 8 are present in all embodiments, additional components not shown may be present, and any combination of the components may be present in a particular embodiment. These components of computing device 802 are described as follows.

A single processor 810 (e.g., central processing unit (CPU), microcontroller, a microprocessor, signal processor, ASIC (application specific integrated circuit), and/or other physical hardware processor circuit) or multiple processors 810 may be present in computing device 802 for performing such tasks as program execution, signal coding, data processing, input/output processing, power control, and/or other functions. Processor 810 may be a single-core or multi-core processor, and each processor core may be single-threaded or multithreaded (to provide multiple threads of execution concurrently). Processor 810 is configured to execute program code stored in a computer readable medium, such as program code of operating system 812 and application programs 814 stored in storage 820. Operating system 812 controls the allocation and usage of the components of computing device 802 and provides support for one or more application programs 814 (also referred to as “applications” or “apps”). Application programs 814 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 802 can communicate with any other component according to function, although not all connections are shown for case of illustration. For instance, as shown in FIG. 8, bus 806 is a multiple signal line communication medium (e.g., conductive traces in silicon, metal traces along a motherboard, wires, etc.) that may be present to communicatively couple processor 810 to various other components of computing device 802, although in other embodiments, an alternative bus, further buses, and/or one or more individual signal lines may be present to communicatively couple components. Bus 806 represents one or more of any of several types of bus structures, including a memory bus or memory controller, a peripheral bus, an accelerated graphics port, and a processor or local bus using any of a variety of bus architectures.

Storage 820 is physical storage that includes one or both of memory 856 and storage device 890, which store operating system 812, application programs 814, and application data 816 according to any distribution. Non-removable memory 822 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 822 may include main memory and may be separate from or fabricated in a same integrated circuit as processor 810. As shown in FIG. 8, non-removable memory 822 stores firmware 818, which may be present to provide low-level control of hardware. Examples of firmware 818 include BIOS (Basic Input/Output System, such as on personal computers) and boot firmware (e.g., on smart phones). Removable memory 824 may be inserted into a receptacle of or otherwise coupled to computing device 802 and can be removed by a user from computing device 802. Removable memory 824 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 890 may be present that are internal and/or external to a housing of computing device 802 and may or may not be removable. Examples of storage device 890 include a hard disk drive, a SSD, a thumb drive (e.g., a USB (Universal Serial Bus) flash drive), or other physical storage device.

One or more programs may be stored in storage 820. Such programs include operating system 812, one or more application programs 814, and other program modules and program data. Examples of such application programs may include, for example, computer program logic (e.g., computer program code/instructions) for implementing one or more of incident data processor 110, automatic taxonomy generator 112, root cause taxonomy storage 114, incident classifier 116, parser 202, preprocessor 204, feature merger 206, pattern identifier 208, hierarchy generator 210, action handler 212, and/or each of the components described therein, along with any components and/or subcomponents thereof, as well as the flowcharts/flow diagrams (e.g., flowcharts 300, 400, 500, 600, and/or 700) described herein, including portions thereof, and/or further examples described herein.

Storage 820 also stores data used and/or generated by operating system 812 and application programs 814 as application data 816. Examples of application data 816 include web pages, text, images, tables, sound files, video data, and other data, which may also be sent to and/or received from one or more network servers or other devices via one or more wired or wireless networks. Storage 820 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 802 through one or more input devices 830 and may receive information from computing device 802 through one or more output devices 850. Input device(s) 830 may include one or more of touch screen 832, microphone 834, camera 836, physical keyboard 838 and/or trackball 840 and output device(s) 850 may include one or more of speaker 852 and display 854. Each of input device(s) 830 and output device(s) 850 may be integral to computing device 802 (e.g., built into a housing of computing device 802) or external to computing device 802 (e.g., communicatively coupled wired or wirelessly to computing device 802 via wired interface(s) 880 and/or wireless modem(s) 860). Further input devices 830 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 854 may display information, as well as operating as touch screen 832 by receiving user commands and/or other information (e.g., by touch, finger gestures, virtual keyboard, etc.) as a user interface. Any number of each type of input device(s) 830 and output device(s) 850 may be present, including multiple microphones 834, multiple cameras 836, multiple speakers 852, and/or multiple displays 854.

One or more wireless modems 860 can be coupled to antenna(s) (not shown) of computing device 802 and can support two-way communications between processor 810 and devices external to computing device 802 through network 804, as would be understood to persons skilled in the relevant art(s). Wireless modem 860 is shown generically and can include a cellular modem 866 for communicating with one or more cellular networks, such as a GSM network for data and voice communications within a single cellular network, between cellular networks, or between the mobile device and a public switched telephone network (PSTN). Wireless modem 860 may also or alternatively include other radio-based modem types, such as a Bluetooth modem 864 (also referred to as a “Bluetooth device”) and/or Wi-Fi 862 modem (also referred to as an “wireless adaptor”). Wi-Fi modem 862 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 864 is configured to communicate with another Bluetooth-capable device according to the Bluetooth short-range wireless technology standard(s) such as IEEE 802.15.1 and/or managed by the Bluetooth Special Interest Group (SIG).

Computing device 802 can further include power supply 882, LI receiver 884, accelerometer 886, and/or one or more wired interfaces 880. Example wired interfaces 880 include a USB port, IEEE 1394 (Fire Wire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 880 of computing device 802 provide for wired connections between computing device 802 and network 804, or between computing device 802 and one or more devices/peripherals when such devices/peripherals are external to computing device 802 (e.g., a pointing device, display 854, speaker 852, camera 836, physical keyboard 838, etc.). Power supply 882 is configured to supply power to each of the components of computing device 802 and may receive power from a battery internal to computing device 802, and/or from a power cord plugged into a power port of computing device 802 (e.g., a USB port, an A/C power port). LI receiver 884 may be used for location determination of computing device 802 and may include a satellite navigation receiver such as a Global Positioning System (GPS) receiver or may include other type of location determiner configured to determine location of computing device 802 based on received information (e.g., using cell tower triangulation, etc.). Accelerometer 886 may be present to determine an orientation of computing device 802.

Note that the illustrated components of computing device 802 are not required or all-inclusive, and fewer or greater numbers of components may be present as would be recognized by one skilled in the art. For example, computing device 802 may also include one or more of a gyroscope, barometer, proximity sensor, ambient light sensor, digital compass, etc. Processor 810 and memory 856 may be co-located in a same semiconductor device package, such as being included together in an integrated circuit chip, FPGA, or system-on-chip (SOC), optionally along with further components of computing device 802.

In embodiments, computing device 802 is configured to implement any of the above-described features of flowcharts herein. Computer program logic for performing any of the operations, steps, and/or functions described herein may be stored in storage 820 and executed by processor 810.

In some embodiments, server infrastructure 870 may be present in computing environment 800 and may be communicatively coupled with computing device 802 via network 804. Server infrastructure 870, when present, may be a network-accessible server set (e.g., a cloud-based environment or platform). As shown in FIG. 8, server infrastructure 870 includes clusters 872. Each of clusters 872 may comprise a group of one or more compute nodes and/or a group of one or more storage nodes. For example, as shown in FIG. 8, cluster 872 includes nodes 874. Each of nodes 874 are accessible via network 804 (e.g., in a “cloud-based” embodiment) to build, deploy, and manage applications and services. Any of nodes 874 may be a storage node that comprises a plurality of physical storage disks, SSDs, and/or other physical storage devices that are accessible via network 804 and are configured to store data associated with the applications and services managed by nodes 874. For example, as shown in FIG. 8, nodes 874 may store application data 878.

Each of nodes 874 may, as a compute node, comprise one or more server computers, server systems, and/or computing devices. For instance, a node 874 may include one or more of the components of computing device 802 disclosed herein. Each of nodes 874 may be configured to execute one or more software applications (or “applications”) and/or services and/or manage hardware resources (e.g., processors, memory, etc.), which may be utilized by users (e.g., customers) of the network-accessible server set. For example, as shown in FIG. 8, nodes 874 may operate application programs 876. In an implementation, a node of nodes 874 may operate or comprise one or more virtual machines, with each virtual machine emulating a system architecture (e.g., an operating system), in an isolated manner, upon which applications such as application programs 876 may be executed.

In an embodiment, one or more of clusters 872 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 872 may be a datacenter in a distributed collection of datacenters. In embodiments, exemplary computing environment 800 comprises part of a cloud-based platform such as Amazon Web Services® of Amazon Web Services, Inc. or Google Cloud Platform™ of Google LLC, although these are only examples and are not intended to be limiting.

In an embodiment, computing device 802 may access application programs 876 for execution in any manner, such as by a client application and/or a browser at computing device 802. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 802 may additionally and/or alternatively synchronize copies of application programs 814 and/or application data 816 to be stored at network-based server infrastructure 870 as application programs 876 and/or application data 878. For instance, operating system 812 and/or application programs 814 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 820 at network-based server infrastructure 870.

In some embodiments, on-premises servers 892 may be present in computing environment 800 and may be communicatively coupled with computing device 802 via network 804. On-premises servers 892, when present, are hosted within an organization's infrastructure and, in many cases, physically onsite of a facility of that organization. On-premises servers 892 are controlled, administered, and maintained by IT (Information Technology) personnel of the organization or an IT partner to the organization. Application data 898 may be shared by on-premises servers 892 between computing devices of the organization, including computing device 802 (when part of an organization) through a local network of the organization, and/or through further networks accessible to the organization (including the Internet). Furthermore, on-premises servers 892 may serve applications such as application programs 896 to the computing devices of the organization, including computing device 802. Accordingly, on-premises servers 892 may include storage 894 (which includes one or more physical storage devices such as storage disks and/or SSDs) for storage of application programs 896 and application data 898 and may include one or more processors for execution of application programs 896. Still further, computing device 802 may be configured to synchronize copies of application programs 814 and/or application data 816 for backup storage at on-premises servers 892 as application programs 896 and/or application data 898.

Embodiments described herein may be implemented in one or more of computing device 802, network-based server infrastructure 870, and on-premises servers 892. For example, in some embodiments, computing device 802 may be used to implement systems, clients, or devices, or components/subcomponents thereof, disclosed elsewhere herein. In other embodiments, a combination of computing device 802, network-based server infrastructure 870, and/or on-premises servers 892 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk. SSD, other physical hardware media such as RAMs, ROMs, flash memory, digital video disks, zip disks, MEMs (microelectronic machine) memory, nanotechnology-based storage devices, and further types of physical/tangible hardware storage media of storage 820. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 814) may be stored in storage 820. Such computer programs may also be received via wired interface(s) 880 and/or wireless modem(s) 860 over network 804. Such computer programs, when executed or loaded by an application, enable computing device 802 to implement features of embodiments discussed herein. Accordingly, such computer programs represent controllers of the computing device 802.

Embodiments are also directed to computer program products comprising computer code or instructions stored on any computer-readable medium or computer-readable storage medium. Such computer program products include the physical storage of storage 820 as well as further physical storage types.

### IV. Additional Example Embodiments

In an embodiment, a method includes: receiving a top-level classification for a root cause taxonomy, the top-level classification associated with a top-level term; receiving incident data; processing the incident data to generate processed data; analyzing the processed data to extract patterns in the processed data; generating, based on the extracted patterns, a second-level classification for the root cause taxonomy; and classifying, based on the root cause taxonomy, an incident in the incident data to generate an incident classification.

In an embodiment, analyzing the processed data to extract patterns in the processed data comprises determining, based on the processed data, a second-level term that has a cooccurrence frequency with the top-level term that satisfies a first predetermined relationship with a first frequency threshold.

In an embodiment, generating, based on the extracted patterns, a second-level classification for the root cause taxonomy comprises: creating the second-level classification, the second-level classification associated with the second-level term; and adding the second-level classification to the root cause taxonomy as a child of the top-level classification.

In an embodiment, the method further includes: determining, based on the processed data, a third-level term that has a cooccurrence frequency with the top-level term or the second-level term that satisfies a second predetermined relationship with second a frequency threshold; creating the third-level classification, the third-level classification associated with the third-level term; and adding the third-level classification to the root cause taxonomy as a child of the second-level classification.

In an embodiment, processing the incident data comprises at least one of: converting the incident data into a string format; removing special characters from the incident data; removing contractions from the incident data; removing excess spaces from the incident data; removing placeholder text from the incident data; removing hyperlinks from the incident data; removing universal resource locators (URLs) from the incident data; replacing text in the incident data matching a regular expression (regex) with replacement text; performing case normalization on the incident data; preprocessing specific fields in the incident data; replacing underscores in the incident data with a replacement character; tokenizing the incident data; removing stop words from the incident data; or lemmatizing the incident data.

In an embodiment, the method further includes at least one of: providing a notification based on the incident classification; providing a recommendation based on the incident classification; providing descriptive statistics based on the incident classification; providing prioritization guidance based on the incident classification; automatically performing a remedial action based on the incident classification; or updating the root cause taxonomy based on the incident classification.

In an embodiment, the method further includes: determining a field of the incident data without a corresponding value as an empty field; determining, based on the incident data, a probable value for the empty field, the probable value being associated with a confidence score that satisfies a predetermined relationship with a confidence threshold; and associating, in the incident data, the empty field with the probable value.

In an embodiment, a system includes a processor; and a memory device stores program code structured to cause the processor to: receive a top-level classification for a root cause taxonomy, the top-level classification associated with a top-level term; receive incident data; process the incident data to generate processed data; analyze the processed data to extract patterns in the processed data; generate, based on the extracted patterns, a second-level classification for the root cause taxonomy; and classify, based on the root cause taxonomy, an incident in the incident data to generate an incident classification.

In an embodiment, to analyze the processed data to extract patterns in the processed data, the program code is further structured to cause the processor to: determine, based on the processed data, a second-level term that has a cooccurrence frequency with the top-level term that satisfies a first predetermined relationship with a first frequency threshold.

In an embodiment, to generate, based on the extracted patterns, a second-level classification for the root cause taxonomy, the program code is further structured to cause the processor to: create the second-level classification, the second-level classification associated with the second-level term; and add the second-level classification to the root cause taxonomy as a child of the top-level classification.

In an embodiment, the program code is further structured to cause the processor to: determine, based on the processed data, a third-level term that has a cooccurrence frequency with the top-level term or the second-level term that satisfies a second predetermined relationship with second a frequency threshold; create a third-level classification, the third-level classification associated with the third-level term; and add the third-level classification to the root cause taxonomy as a child of the second-level classification.

In an embodiment, to process the incident data, the program code is further structured to cause the processor to: convert the incident data into a string format; remove special characters from the incident data; remove contractions from the incident data; remove hyperlinks from the incident data; remove excess spaces from the incident data; remove placeholder text from the incident data; remove universal resource locators (URLs) from the incident data; replace text in the incident data matching a regular expression (regex) with replacement text; perform case normalization on the incident data; preprocess specific fields in the incident data; replace underscores in the incident data with a replacement character; tokenize the incident data; remove stop words from the incident data; or lemmatize the incident data.

In an embodiment, the program code is further structured to cause the processor to perform at least one of: provide a notification based on the incident classification; provide a recommendation based on the incident classification; provide descriptive statistics based on the incident classification; provide prioritization guidance based on the incident classification; automatically perform a remedial action based on the incident classification; or update the root cause taxonomy based on the incident classification.

In an embodiment, the program code is further structured to cause the processor to: determine a field of the incident data without a corresponding value as an empty field; determine, based on the incident data, a probable value for the empty field, the probable value being associated with a confidence score that satisfies a predetermined relationship with a confidence threshold; and associate, in the incident data, the empty field with the probable value.

In an embodiment, a computer-readable storage medium comprising computer-executable instructions that, when executed by a processor, cause the processor to: receive a top-level classification for a root cause taxonomy, the top-level classification associated with a top-level term; receive incident data; process the incident data to generate processed data; analyze the processed data to extract patterns in the processed data; generate, based on the extracted patterns, a second-level classification for the root cause taxonomy; and classify, based on the root cause taxonomy, an incident in the incident data to generate an incident classification.

In an embodiment, to analyze the processed data to extract patterns in the processed data, the computer-executable instructions, when executed by the processor, further cause the processor to: determine, based on the processed data, a second-level term that has a cooccurrence frequency with the top-level term that satisfies a first predetermined relationship with a first frequency threshold.

In an embodiment, to generate, based on the extracted patterns, a second-level classification for the root cause taxonomy, the computer-executable instructions, when executed by the processor, further cause the processor to: create the second-level classification, the second-level classification associated with the second-level term; and add the second-level classification to the root cause taxonomy as a child of the top-level classification.

In an embodiment, the computer-executable instructions, when executed by the processor, further cause the processor to: determine, based on the processed data, a third-level term that has a cooccurrence frequency with the top-level term or the second-level term that satisfies a second predetermined relationship with second a frequency threshold; create a third-level classification, the third-level classification associated with the third-level term; and add the third-level classification to the root cause taxonomy as a child of the second-level classification.

In an embodiment, to process the incident data, the computer-executable instructions, when executed by the processor, further cause the processor to: convert the incident data into a string format; remove special characters from the incident data; remove contractions from the incident data; remove excess spaces from the incident data; remove placeholder text from the incident data; remove hyperlinks from the incident data; remove universal resource locators (URLs) from the incident data; replace text in the incident data matching a regular expression (regex) with replacement text; perform case normalization on the incident data; preprocess specific fields in the incident data; replace underscores in the incident data with a replacement character; tokenize the incident data; remove stop words from the incident data; or lemmatize the incident data.

In an embodiment, the computer-executable instructions, when executed by the processor, further cause the processor to perform at least one of: provide a notification based on the incident classification; provide a recommendation based on the incident classification; provide descriptive statistics based on the incident classification; provide prioritization guidance based on the incident classification; automatically perform a remedial action based on the incident classification; or update the root cause taxonomy based on the incident classification.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

1. A method comprising:
receiving a top-level classification for a root cause taxonomy, the top-level classification associated with a top-level term;
receiving incident data;
processing the incident data to generate processed data;
determining, based on the processed data, a second-level term that has a cooccurrence frequency with the top-level term that satisfies a first predetermined relationship with a first frequency threshold;
generating, based on the second-level term, a second-level classification for the root cause taxonomy;
classifying, by a machine learning model based on the root cause taxonomy, an incident in the incident data to generate an incident classification; and
performing a remedial action based on the incident classification.

2. (canceled).

3. The method of claim 1, wherein said generating, based on the second-level term, a second-level classification for the root cause taxonomy comprises:
creating the second-level classification, the second-level classification associated with the second-level term; and
adding the second-level classification to the root cause taxonomy as a child of the top-level classification.

4. The method of claim 3, further comprising:
determining, based on the processed data, a third-level term that has a cooccurrence frequency with the top-level term or the second-level term that satisfies a second predetermined relationship with second a frequency threshold;
creating the third-level classification, the third-level classification associated with the third-level term; and
adding the third-level classification to the root cause taxonomy as a child of the second-level classification.

5. The method of claim 1, wherein said processing the incident data comprises at least one of:
converting the incident data into a string format;
removing special characters from the incident data;
removing contractions from the incident data;
removing excess spaces from the incident data;
removing placeholder text from the incident data;
removing hyperlinks from the incident data;
removing universal resource locators (URLs) from the incident data;
replacing text in the incident data matching a regular expression (regex) with replacement text;
performing case normalization on the incident data;
preprocessing specific fields in the incident data;
replacing underscores in the incident data with a replacement character;
tokenizing the incident data;
removing stop words from the incident data; or
lemmatizing the incident data.

6. The method of claim 1, further comprising at least one of:
providing a notification based on the incident classification;
providing a recommendation based on the incident classification;
providing descriptive statistics based on the incident classification;
providing prioritization guidance based on the incident classification,
automatically performing a remedial action based on the incident classification; or
updating the root cause taxonomy based on the incident classification.

7. The method of claim 1, further comprising:
determining a field of the incident data without a corresponding value as an empty field;
determining, based on the incident data, a probable value for the empty field, the probable value being associated with a confidence score that satisfies a predetermined relationship with a confidence threshold; and
associating, in the incident data, the empty field with the probable value.

8. A system comprising:
a processor; and
a memory device stores program code structured to cause the processor to:
receive a top-level classification for a root cause taxonomy, the top-level classification associated with a top-level term;
receive incident data;
process the incident data to generate processed data;
determine, based on the processed data, a second-level term that has a cooccurrence frequency with the top-level term that satisfies a first predetermined relationship with a first frequency threshold;
generate, based on the second-level term-extracted patterns, a second-level classification for the root cause taxonomy;
classify, based on the root cause taxonomy, an incident in the incident data to generate an incident classification; and
perform a remedial action based on the incident classification.

9. (canceled)

10. The system of claim 8, wherein, to generate, based on the second-level term, a second-level classification for the root cause taxonomy, the program code is further structured to cause the processor to:
create the second-level classification, the second-level classification associated with the second-level term; and
add the second-level classification to the root cause taxonomy as a child of the top-level classification.

11. The system of claim 10, wherein the program code is further structured to cause the processor to:
determine, based on the processed data, a third-level term that has a cooccurrence frequency with the top-level term or the second-level term that satisfies a second predetermined relationship with second a frequency threshold;
create a third-level classification, the third-level classification associated with the third-level term; and
add the third-level classification to the root cause taxonomy as a child of the second-level classification.

12. The system of claim 8, wherein, to process the incident data, the program code is further structured to cause the processor to:
convert the incident data into a string format;
remove special characters from the incident data;
remove contractions from the incident data;
remove excess spaces from the incident data;
remove placeholder text from the incident data;
remove hyperlinks from the incident data;
remove universal resource locators (URLs) from the incident data;
replace text in the incident data matching a regular expression (regex) with replacement text;
perform case normalization on the incident data;
preprocess specific fields in the incident data;
replace underscores in the incident data with a replacement character;
tokenize the incident data;
remove stop words from the incident data; or
lemmatize the incident data.

13. The system of claim 8, wherein the program code is further structured to cause the processor to perform at least one of:
provide a notification based on the incident classification;
provide a recommendation based on the incident classification;
provide descriptive statistics based on the incident classification;
provide prioritization guidance based on the incident classification,
automatically perform a remedial action based on the incident classification; or
update the root cause taxonomy based on the incident classification.

14. The system of claim 8, wherein the program code is further structured to cause the processor to:
determine a field of the incident data without a corresponding value as an empty field;
determine, based on the incident data, a probable value for the empty field, the probable value being associated with a confidence score that satisfies a predetermined relationship with a confidence threshold; and
associate, in the incident data, the empty field with the probable value.

15. A computer-readable storage medium comprising computer-executable instructions that, when executed by a processor, cause the processor to:
receive a top-level classification for a root cause taxonomy, the top-level classification associated with a top-level term;
receive incident data;
process the incident data to generate processed data;
determine, based on the processed data, a second-level term that has a cooccurrence frequency with the top-level term that satisfies a first predetermined relationship with a first frequency threshold;
generate, based on the second-level term, a second-level classification for the root cause taxonomy;
classify, based on the root cause taxonomy, an incident in the incident data to generate an incident classification; and
perform a remedial action based on the incident classification.

16. (canceled)

17. The computer-readable storage medium of claim 15, wherein, to generate, based on the second-level term, a second-level classification for the root cause taxonomy, the computer-executable instructions, when executed by the processor, further cause the processor to:
create the second-level classification, the second-level classification associated with the second-level term; and
add the second-level classification to the root cause taxonomy as a child of the top-level classification.

18. The computer-readable storage medium of claim 17, wherein the computer-executable instructions, when executed by the processor, further cause the processor to:
determine, based on the processed data, a third-level term that has a cooccurrence frequency with the top-level term or the second-level term that satisfies a second predetermined relationship with second a frequency threshold;
create a third-level classification, the third-level classification associated with the third-level term; and
add the third-level classification to the root cause taxonomy as a child of the second-level classification.

19. The computer-readable storage medium of claim 15, wherein, to process the incident data, the computer-executable instructions, when executed by the processor, further cause the processor to:
convert the incident data into a string format;
remove special characters from the incident data;
remove contractions from the incident data;
remove excess spaces from the incident data;
remove placeholder text from the incident data;
remove hyperlinks from the incident data;
remove universal resource locators (URLs) from the incident data;
replace text in the incident data matching a regular expression (regex) with replacement text;
perform case normalization on the incident data;
preprocess specific fields in the incident data;
replace underscores in the incident data with a replacement character;
tokenize the incident data;
remove stop words from the incident data; or
lemmatize the incident data.

20. The computer-readable storage medium of claim 15, wherein the computer-executable instructions, when executed by the processor, further cause the processor to perform at least one of:
provide a notification based on the incident classification;
provide a recommendation based on the incident classification;
provide descriptive statistics based on the incident classification;
provide prioritization guidance based on the incident classification,
automatically perform a remedial action based on the incident classification; or
update the root cause taxonomy based on the incident classification.

21. The method of claim 1, wherein said performing a remedial action comprises:
automatically performing the remedial action to remediate the incident.

22. The system of claim 8, wherein, to classify the incident data, the computer code is structured to cause the processor to:
employ a machine learning classification model to classify the incident into the incident classification.

23. The computer-readable storage medium of claim 15, wherein, to classify the incident data, the computer code is structured to cause the processor to:
employ a machine learning classification model to classify the incident into the incident classification.
